(19) United States
(12) Patent Application Publication
(10) Pub. No.: US 2026/0368192 A1
(43) Pub. Date: Nov. 19, 2026

(54) INTELLIGENT RESEARCH TOOL WITH SUB-TASK AUTOMATION

(71) Applicant: GDM Holding LLC, Mountain View, CA (US)

(72) Inventors: Shuli Liu, Castro Valley, CA (US); Brian Baugh, Seattle, WA (US); Kristen Maxwell, Austin, TX (US); Nathan Goodell, Monroe, WA (US); Geoff Barnes, Pittsburgh, PA (US); Adam Garbacz, Seattle, WA (US); Courtney Kellner, Brooklyn, NY (US); Nikhil Dev, Cupertino, CA (US); Youbin Nanni, McMinnville, OR (US)

(21) Appl. No.: 19/212,300

(22) Filed: May 19, 2025

(51) Int. Cl. G06F 16/248

(52) U.S. Cl. CPC G06F 16/248

(57) ABSTRACT

Some implementations herein relate to a computer-implemented process that can include generating a prompt related to a research task based on user input and generating a plurality of research sub-tasks. Implementations can further render the plurality of sub-tasks and resources to be used and utilizing the user selected resources to perform the research task. Some implementations can render textual and non-textual elements, generated by one or more generative models, to the user, in which the elements can be based on the research results. Other implementations may be described and/or claimed.

### BACKGROUND

Because of the proliferation of information and the increasing complexity of research tasks, it may be desirable to have more efficient and effective research methodologies.

Traditionally, researchers have relied on manual methods, such as literature reviews, data collection, and analysis, to conduct research. However, these methods can be time-consuming, labor-intensive, and prone to human error.

Search engines and online databases can provide access to a vast amount of information, but they can lack the ability to synthesize and analyze this information in a meaningful way. As a result, researchers can be overwhelmed by the sheer volume of search results, and so struggle to identify the most relevant and reliable resources. Furthermore, these tools can require users to manually extract and analyze data, which can be a tedious and error-prone process.

Some legacy techniques have attempted to address these limitations through automated literature reviews and data extraction techniques. However, these approaches often suffer from several drawbacks. First, they can be limited in their ability to handle diverse data formats and resources. Second, they can lack the sophistication to accurately identify and extract relevant information from complex documents. Third, legacy solutions can fail to provide a comprehensive and integrated research environment that supports the entire research workflow, from initial query formulation to final report generation.

### SUMMARY

Implementations disclosed herein can relate to a computer-implemented process. The process can include generating a prompt related to a research task based on user input to an electronic device for processing using one or more generative models (GMs). A plurality of research sub-tasks related to performance of the research task can then be generated based on the prompt using the one or more GMs. The process can then include rendering, to the user, one or more indications of the plurality of research sub-tasks and one or more indications of one or more resources to be used for performance of the research task. User input related to selection of a subset of the one or more resources can then be identified based on the rendering of the one or more indications of the plurality of research sub-tasks to the user, and in response, the subset of the one or more resources can then be utilized in performance of the research task.

In some implementations, the user input related to selection might include selection/confirmation of presented resource options. For example, the user might be presented with several options for resources and/or resource categories, and affirmatively select some subset of the presented options (e.g., ticking a box next to one or more of the listed options or some other type of affirmative selection to indicate resource(s) that are to be used in performance of the research task). In some implementations, the user input related to selection might additionally/alternatively include de-selection of presented resource options. For example, the user might be presented with several options for resources and/or resource categories, and affirmatively de-select some subset of the presented options (e.g., ticking a box next to one or more of the listed resource options to indicate resources that are not to be used in performance of the resource task).

Additional or alternative implementations disclosed herein can relate to a computer-implemented process wherein a prompt related to a research task can be generated. The prompt can be for processing using one or more GMs, and the prompt can be based on user input by a user to an electronic device. The one or more GMs can be used to generate a plurality of research sub-tasks related to performance of the research task based on the prompt. Research results can then be then generated based on the processing of one or more of the plurality of research sub-tasks by the one or more GMs and/or one or more additional GMs. These research results can be rendered to the user by rendering a textual element based on the research results. One or more non-textual elements can also be rendered based on the research results. The non-textual element can be generated using the one or more GMs and/or the one or more additional GMs.

Implementations disclosed herein can mitigate (e.g., reduce and/or eliminate) various drawbacks with legacy techniques related to research, automation and integration. For example, by employing GMs, diverse data formats and resources can be processed dynamically, enabling the research tool to adapt to a wider variety of information repositories beyond traditional databases. As another example, sophisticated natural language processing and machine learning techniques can be utilized to accurately identify and extract relevant information from complex documents with a degree of precision that surpasses older, less nuanced solutions. As another example, disclosed implementations can provide a comprehensive and integrated research environment by supporting the entire research workflow, from initial query formulation based on user input provided by the user at a user prompt, to the final generation of a multi-faceted research report complete with visualizations, insights, and audio summaries.

Additionally or alternatively, some implementations disclosed herein can further mitigate various drawbacks with legacy techniques related to identifying and retrieving relevant resources. For example, with the ability for a user to upload custom documents or select from specialized corpora such as online research databases or online video repositories, research can be narrowly targeted to resources that have higher relevance to the topic of the research task than may otherwise be possible using broad Internet searches. As another example, techniques disclosed herein can provide pre-selected resources depending on content from the prompt to give relevant results while also allowing granular selections for users. As another example, the user can be enabled to block the research of a particular resource or a set of resources, which can lead to reduced computational load as resources that are known to be misleading or relevant can be skipped rather than analyzed and refined.

Further, in some implementations the system or systems that perform the research task (or parts thereof) might be configured to analyze and synthesize information from various of the identified resources. In these implementations, the system's computational load might be reduced by using certain resources and de-selecting others. For example, the computational load that occurs through synthesizing data from a plurality of resources with less relevance might be significantly greater than the load involved with synthesizing data from a plurality of more relevant or related resources. Additionally, certain resources might be de-selected if they are particularly load-intensive (e.g., analysis and synthesis of complicated video files as opposed to relatively simpler text documents), thereby allowing for the research task to be implemented on systems with differing processing power.

As a non-limiting example of some implementations disclosed herein, suppose a user, a college student researching climate change, provides natural language input such as “Analyze the economic impact of transitioning to renewable energy sources.” The system could generate sub-tasks such as: “Identify current government subsidies for fossil fuels,” “Compare the cost of solar versus coal energy production,” “Project job growth in the renewable energy sector,” and “Assess the impact on consumer energy prices.” In rendering indications of these sub-tasks, the system might also suggest resources like a governmental Energy Agency database, academic journals on environmental economics, and reports from international organizations related to climate change. The user, knowing that specific countries have different economic models, could then select to refine the research to the data from a specific country or locale as the relevant subset of resources to be utilized for deeper analysis within the research sub-tasks.

As another non-limiting example of some implementations disclosed herein, consider a researcher studying public opinion on electric vehicles. The system could initially suggest categories such as “news articles,” “government reports,” “social media posts,” and “academic studies.” Recognizing that social media often contains unreliable or biased information, the user might choose to de-select the “social media posts” category, thereby narrowing the research focus to more credible resources like “news articles,” “government reports,” and “academic studies.” This configuration might therefore allow the researcher to prioritize high-quality, fact-checked information over potentially misleading public sentiment.

As another non-limiting example of some implementations disclosed herein, a user might ask for information related to a research task such as “Explain the impact of social media on political polarization.” The system could generate sub-tasks such as: “Identify trends in social media usage across different demographics,” “Analyze sentiment in political discourse on social media websites,” “Compare news consumption patterns among users of different social media platforms,” and “Quantify the correlation between echo chambers and voting behavior.” Upon executing these sub-tasks, the system might provide a textual summary highlighting key findings such as the role of algorithms in reinforcing biases. Additionally, the system might generate and provide an interactive network graph illustrating how information spreads within different online communities. Further, the system might generate and provide an audio summary that distills complex patterns into easily digestible insights. The combination of these different textual and non-textual elements might therefore give a more detailed perspective of the research in a variety of alternative forms.

In some implementations, prior to generating a prompt related to a research task, resources might be pre-identified/pre-configured. For instance, the resources may be academic journals, websites, or videos for performing the sub-tasks. To illustrate this, before a user types in the research task, the resources, such as specific databases, websites, or documents might be pre-identified and/or pre-configured.

In some implementations, resources used for performing the research sub-tasks can be identified based on the sub-tasks themselves, or based on topics related to the research sub-tasks. For example, the user might enter the phrase “climate change.” The system could then suggest the resources such as: “academic databases,” “government websites,” or “research papers.”

The output of the research might include one or more non-textual elements. For example, the output of the research might include an audio element to convey the information rather than text. Additionally or alternatively, the non-textual element may include a graph or a flowchart for conveying the information to the user. In some implementations, the non-textual element might include a video. In some implementations, some or all of the non-textual content might be generated by one or more of the GMs. In some implementations, some or all of the non-textual content might be pre-generated content from one or more of the research resources. Such content might be identified by one or more of the GMs and then included (with appropriate attribution and/or citations) in the research results.

The textual information provided can be supplemented with content generated using one or more GMs to provide more information on the research topic. For example, the system could use one or more GMs to provide an executive summary highlighting key findings or propose further questions to investigate based on the results.

The system might also provide information as to the resources that were utilized for the research task. For example, a section of the output may indicate to the user which academic journals, websites, videos or other resources were researched. The information provided can then be rendered on the display, either in-line with the other information, or in a separate portion of the display.

It will be understood that implementations herein can be described with respect to a vision language model (VLM). As used herein, a VLM can refer to a type of GM that is capable of accepting inputs in a variety of modalities such as text-based inputs and vision-based inputs. In implementations, the text-based inputs can be based on inputs that are typed by a user into the phone via a keyboard that is presented to the user on the screen of the phone, wirelessly coupled with the phone, coupled with the phone by a wired connection, etc. In other implementations, the text-based inputs can be based on or related to a transcription of an audio input by the user (e.g., via a speech-to-text program). In these implementations, the text-based input can be in a user-readable form or in some type of machine language or non-user readable form. Based on the input, the VLM can generate and/or provide an output in one or more modalities including a text-based output, a visual output, an audio output, and/or some other type of output.

It will be understood that the use of VLM in herein is intended as a non-limiting for the sake of example and discussion. Other implementations can include one or more additional or alternative GMs such as a large language model (LLM), a recurrent neural network (RNN), a transformer model, and/or some other type of GM.

The preceding is presented as an overview of only some implementations disclosed herein. These and other implementations are disclosed in additional detail herein.

### BRIEF DESCRIPTION OF THE DRAWINGS

FIG. 1 schematically depicts an example environment in which selected aspects of the present disclosure may be implemented, in accordance with various implementations.

FIG. 2 depicts an example of a user interface, in accordance with various implementations.

FIG. 3 depicts an alternative example of a user interface, in accordance with various implementations.

FIG. 4 depicts an alternative example of a user interface, in accordance with various implementations.

FIG. 5 depicts an alternative example of a user interface, in accordance with various implementations.

FIG. 6 depicts an example of a research report, in accordance with various implementations.

FIG. 7 depicts an example process, in accordance with various implementations.

FIG. 8 depicts an alternative example process, in accordance with various implementations.

FIG. 9 schematically depicts an example architecture of a computer system, in accordance with various implementations.

### DETAILED DESCRIPTION

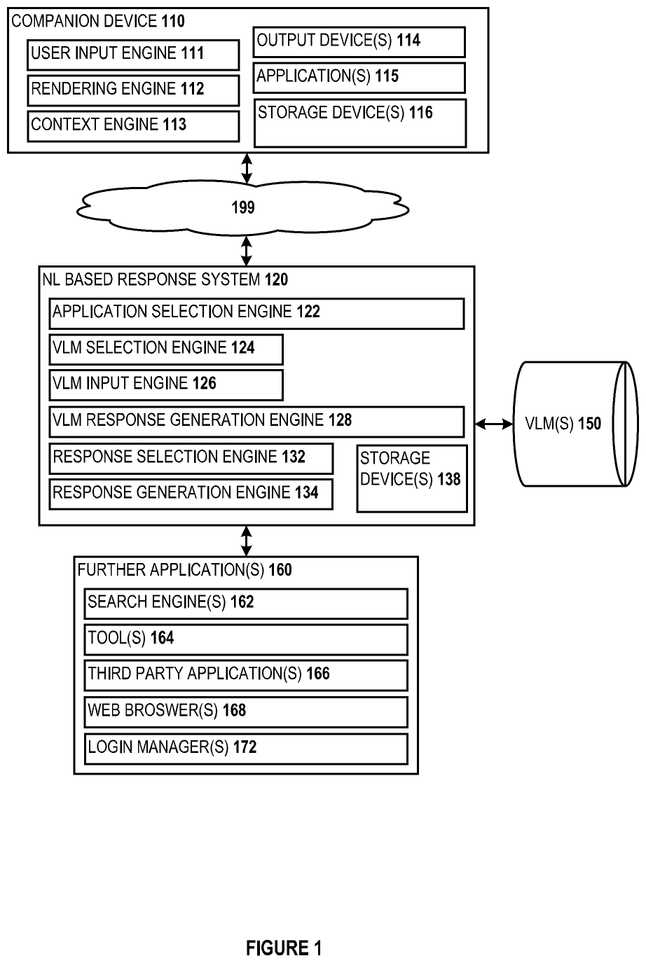

Turning now to FIG. 1, a block diagram of an example environment that demonstrates various aspects of the present disclosure, and in which implementations disclosed herein can be implemented, is depicted. The example environment can include a companion device 110, a natural language (NL) response system 120, and one or more further applications 160 (e.g., applications external to a VLM or a dialogue application executed on the companion device 110).

Although illustrated as separate elements in FIG. 1, in some implementations, all or aspects of the NL based response system 120 and/or all or aspects of the one or more further applications 160 can be implemented as part of a cohesive system. In some implementations, all or aspects of the NL based response system 120 and/or the further applications 160 can be implemented locally at the companion device 110 (e.g., as part of a single physical unit such as a single cellular telephone, personal digital assistant (PDA), tablet device, laptop, desktop computer, etc.). In additional or alternative implementations, all or aspects of the NL based response system 120 and/or one or more electronic devices that implement or include the further applications 160 can be implemented remotely from the companion device 110 as depicted in FIG. 1 (e.g., at one or more remote server(s)). In those implementations, the companion device 110 and the NL based response system 120 and/or the electronic device(s) that implement the further application(s) 160 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet, one or more cellular networks, one or more satellite-based networks, etc.).

The companion device 110 can be, for example, one or more of: a desktop computer, a laptop computer, a tablet, a mobile phone, a PDA, a computing device of a vehicle (e.g., an in-vehicle communications system, an in-vehicle entertainment system, an in-vehicle navigation system), a standalone interactive speaker having a display, a smart appliance such as a smart television or smart refrigerator, and/or a wearable apparatus of the user that includes a computing device (e.g., a watch of the user having a computing device, glasses of the user having a computing device, a virtual or augmented reality computing device, etc.). Additional and/or alternative companion devices can be provided.

The companion device 110 can execute one or more applications, such as application(s) 115, via which user input related to a research task can be submitted and/or research results can be rendered (e.g., audibly and/or visually). The application(s) 115 can be an application that is separate from an operating system of the companion device 110 (e.g., one installed “on top” of the operating system)—or can alternatively be implemented directly by the operating system of the companion device 110. For example, the application(s) 115 can be a web browser installed on top of the operating system (OS), or can be an application that is integrated as part of the operating system functionality. The application(s) 115 can interact with the NL based response system 120.

In various implementations, the companion device 110 can include a user input engine 111 that is configured to detect user input provided by a user of the companion device 110 using one or more user interface input devices. For example, the companion device 110 can be equipped with one or more microphones that capture audio data, such as audio data corresponding to spoken utterances of the user or other sounds in an environment of the companion device 110. Additionally, or alternatively, the companion device 110 can be equipped with one or more vision components that are configured to capture vision data corresponding to images and/or movements (e.g., gestures) detected in a field of view of one or more of the vision components. Additionally, or alternatively, the companion device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the companion device 110. Some instances of a query described herein can be a query that is formulated based on user input provided by a user of the companion device 110 and detected via user input engine 111. For example, the user input can be input that is typed via a physical or virtual keyboard, a suggested natural language word, sentence, and/or phrase that is selected via a touch screen or a mouse, a spoken voice input that is detected via microphone(s) of the companion device, or an image-related input that is based on an image captured by a vision component of the companion device.

In various implementations, the companion device 110 can include a rendering engine 112 that is configured to provide content (e.g., research results generated based on a research task) for audible and/or visual presentation to a user of the companion device 110 using one or more output devices 114. For example, the output device(s) 114 can be or include one or more speakers that enable content to be provided for audible presentation to the user via the companion device 110. Additionally or alternatively, the output device(s) 114 can be or include one or more monitors or screens on which one or more visual elements can be displayed. Additionally or alternatively, the output device(s) 114 can be or include an alternative type of output device such as a haptic feedback device. Generally, the rendering engine 112 can be configured to receive digital content and facilitate changing the digital content to a user-recognizable format (e.g., sound, one or more visual elements, etc.)

In various implementations, the companion device 110 can include a context engine 113 that is configured to determine a context (e.g., current or recent context) of the companion device 110 and/or of a user of the companion device 110. In some of those implementations, the context engine 113 can determine a context utilizing current or recent interaction(s) via the companion device 110, a location of the companion device 110, profile data of a profile of a user of the companion device 110 (e.g., an active user when multiple profiles are associated with the companion device 110), and/or other data accessible to the context engine 113. For example, the context engine 113 can determine a current context based on a current state of a query session (e.g., considering recent input received from, and output provided to, a user of the companion device 110), profile data, and/or a current location of the companion device 110. As an example, the context engine 113 can determine a current context based on which application is active in the foreground of the companion device 110, a current or recent state of the active application, and/or content currently or recently rendered by the active application. A context determined by the context engine 113 can be utilized, for example, in supplementing or rewriting a query that is formulated based on user input, in generating an implied query (e.g., a query formulated independent of user input), and/or in determining to submit an implied query and/or to render research result(s) (e.g., an NL-based research report that can include textual and non-textual elements as described herein) for an implied query. In some implementations, a context can be based on one or more previous query sessions that were related to a same or similar topic.

The companion device 110 can additionally include one or more storage devices 116. In various implementations, the storage device(s) 116 can be implemented as memory such as non-volatile memory (NVM) like flash memory, a hard disk drive (HDD), read-only memory (ROM), etc. In some implementations, the storage device(s) 116 can be additionally or alternatively implemented as volatile memory such as cache memory, random access memory (RAM), etc. The storage device(s) can, in some implementations, store data and/or one or more software applications (e.g., application(s) 115).

Although not explicitly shown, in some implementations the companion device 110 and/or the NL based response system 120 can include one or more processors for accessing data and executing the software applications (e.g., application(s) 115), and/or other components that facilitate communication over one or more of the networks 199. In some implementations, one or more of the software applications can be installed locally at the companion device 110, whereas in other implementations one or more of the software applications can be hosted remotely (e.g., by one or more servers) and can be accessible by the companion device 110 over one or more of the networks 199.

Although aspects of FIG. 1 are illustrated or described with respect to a single companion device having a single user, it should be understood that such description is for the sake of example and is not meant to be limiting. For example, one or more additional companion devices of a user and/or of additional user(s) can also implement the techniques described herein. For instance, the companion device 110, the one or more additional companion devices, and/or any other computing devices of a user can form an ecosystem of devices that can employ techniques described herein. These additional companion devices and/or computing devices can be in communication with the companion device 110 (e.g., over the network(s) 199). As another example, a given companion device can be utilized by multiple users in a shared setting (e.g., a group of users, a household).

The example NL based response system is illustrated as including an application selection engine 122, a VLM selection engine 124, a VLM input engine 126, a VLM response generation engine 128, a response selection engine 132, a response generation engine 134, and one or more storage devices 138. It will be understood that, in various implementations, various of the engines and/or components can be omitted, combined, or otherwise altered from the configuration depicted. For example, in some implementations, one or more of the engines of the NL based response system 120 can be distributed across one or more computing systems (which might or might not include the companion device 110). In general, NL based response system 120 can be configured to receive a query generated by the companion device 110 (e.g., by the context engine 113) based on natural language input received from the user, and to process the query to generate a response to the query via one or more further applications 160.

In some implementations, as described elsewhere herein, the query might relate to a research task provided by the user. In other words, the user might provide, for example via the user input engine 111, natural language input that indicates that is related to a research topic.

Based on this query, the NL based response system 120 can perform one or more actions as described herein such as identifying one or more resources to be used for the research task, identifying one or more research sub-tasks, identifying one or more GMs to be used in the performance of one or more of the sub-tasks, and/or performing the one or more sub-tasks to generate a research result.

In some implementations, the application selection engine 122 can, in response to receiving a query, determine one or more further applications 160 to invoke. The application selection engine 122 can select applications that are relevant to the query, e.g., determine that the query is directed towards subject matter within the domain of one or more further applications 160, and select/invoke one or more of the further applications 160 in response. For example, if the query involves utilization of a webpage, then the application selection engine 122 can select a web browser application as one of the one or more further applications 160 to then access the webpage. It should be understood that the specifically depicted applications of FIG. 1 are depicted for the sake of example only, and the one or more further applications 160 can include some other application that is accessible at the companion device 110 and/or the NL based response system 120.

The VLM selection engine 124 can, in response to receiving a query, determine which, if any, of multiple GMs (e.g., VLM(s) 150 and/or one or more other multi-modal GMs) to utilize in generating response(s) to the query. For example, the VLM selection engine 124 can select none, one, or multiple GMs to utilize in generating response(s) in furtherance of the research task and/or one or more sub-tasks indicated by the query. In some implementations, the VLM selection engine 124 can optionally utilize one or more classifiers and/or rules (not illustrated).

The VLM input engine 126 can, in response to receiving the user input, generate VLM input that is to be processed using one or more VLMs. As described herein, such VLM input can include query content that is based on the query and/or additional content, such as user-input resources, one or more-preidentified resources, and/or dynamically identified information resources that can be based on, for example, a topic of the query. Such resources can be or include, for example, webpages, social media, academic articles, caselaw, video content, and/or some other type or style of content.

In some implementations, the resources can additionally or alternatively include resources such as files on the user's computer, or on a computer (e.g., another workstation or a server) of the user's and/or the user's organization. In some implementations, the resources may be stored remotely (e.g., in a cloud drive or some other remote storage location). In these implementations, the user may be prompted, either at the time of processing the query or prior to provision of the user's input, to provide one or more indications of one or more locations of the user's computer and/or other computers of the network where the system can search for resources. For example, the user may configure specific computers, specific directories, etc. in which the system can acquire resources for use in generating the VLM input. In these implementations, the system might be programmed to refrain from searching other locations of the user's computer and/or the remote or local computer's of the user's network or organization.

In some implementations, the VLM input can further be based on context provided by the context engine 113. In some implementations, the VLM input can further be based on additional user input such as selection or de-selection of one or more candidate resources, or a refinement to a research task and/or a research sub-task.

The VLM response generation engine 128 can process VLM input that is generated by the VLM input engine 126, using a VLM such as one of VLMs 150, to generate one or more candidate responses that are responsive to the query. The candidate responses can include, for example, results of performing a research task or one or more of the research sub-tasks. For example, the candidate responses can include one or more textual elements and/or one or more non-textual elements. The non-textual elements can be or include, for example, an audio element, a video element, some other type of visual element (e.g., a picture or a graph), and/or some other type of element as described herein. In some implementations, the candidate responses can be or include, for example, generation or identification of one or more sub-tasks related to the research task. In some implementations, the candidate responses can be or include, for example, identification of one or more resources that are to be used for the research task. It will be understood that these descriptions are intended as non-limiting descriptions of possible data that can be generated for candidate responses, and other implementations can include one or more additional or alternative types or data.

The response selection engine 132 can select one or more responses from, for example, the set of candidate responses output by the VLM response generation engine 128. The response selection engine 132 can, in some examples, select the candidate response with the highest confidence score for performance by the user device 110. In some examples, the response selection engine 132 can compare the confidence scores of the candidate responses to a threshold score. The selected response can be selected from the set of candidate responses with a confidence score that exceeds the threshold score. If no candidate response has a confidence score that exceeds the threshold score, the response selection engine 132 can select a default response, e.g., a response that outputs a request for further information from the user (e.g., via the companion device 110).

The response generation engine 134 can convert the response selected by the response section engine 132 into one or more commands for an application that, when implemented by an application on the companion device, 110, or by one or more further applications 160 cause the application to perform the action that is related to the response. In some implementations as described herein, the action performed might be rendering (for example on a display of companion device 110 via rendering engine 112) one or more of the generated textual and/or non-textual elements of the research results based on the selected candidate response. In some implementations, the action performed might involve rendering one or more candidate resources that are to be used in the performance of the research task. In some implementations, the action performed might involve rendering one or more of the research sub-tasks that were identified based on the query and/or the research task.

The NL based response system 120 can further include one or more storage devices 138. The one or more storage devices 138 can be similar to, and share one or more characteristics with, the one or more storage devices 116. In some implementations, for example implementations where the NL based response system 120 and the companion device 110 are implemented as a single physical unit (e.g., a smart phone or tablet or some other similar device), the one or more storage devices 116 and 138 can be the same storage device (e.g., a single storage device with no redundancy) or there can be two or more distinct storage devices or types of storage devices.

The one or more further applications 160 is illustrated as including one or more search engines 162, one or more tools 164, one or more third-party applications 164, one or more web browsers 166 and/or one or more login managers 170. Some of the applications can be omitted in various implementations. Further applications can also be included in the one or more further applications 160, such as one or more first party applications and/or other applications. The one or more further applications 160 can be executed on a virtual machine, e.g., in a secure virtual environment, such as in a secure environment in the cloud or locally on the companion device 110.

The one or more search engines 162 can receive a search request from the NL based response system 120 and/or companion device 110 and perform a search operation on a search space. The one or more search engines 162 can return one or more search results to the NL based response system 120 and/or the companion device 110. The one or more search engines 162 can include an internet search engine.

The one or more tools 164 can include, for example, applications that can be used to perform creative tasks, such as one or more image tools for creating and/or editing images, one or more document tools for reading, writing and/or editing documents, one or more audio tools for listening to, creating and/or editing audio. For example, in some implementations the one or more tools 164 could be used by one or more elements of the NL based response system 120 to generate a non-textual element as previously described. Many other examples are possible and are also contemplated herein.

The one or more third party applications 166 can include applications that are hosted and/or controlled by a third party for providing access to services that they provide. Examples of such third party applications include, but are not limited to: booking applications; e-commerce applications; translation applications; utility provider applications; calendar/diary applications; and/or the like.

The one or more web browsers 168 can be or refer to applications that provide access to internet webpages.

The one or more login managers 170 can securely store login credentials (e.g., login names, passwords, etc.) of a user for respective application and/or webpages. The login manager can automatically input relevant login details to an application when it is accessed and/or to a webpage when it is loaded. However, it should be noted that the NL based response system 120 can ensure that any login credentials are not included in any VLM input, but the response selection engine 132 and/or the response generation engine 134 can cause any needed login credentials to be utilized.

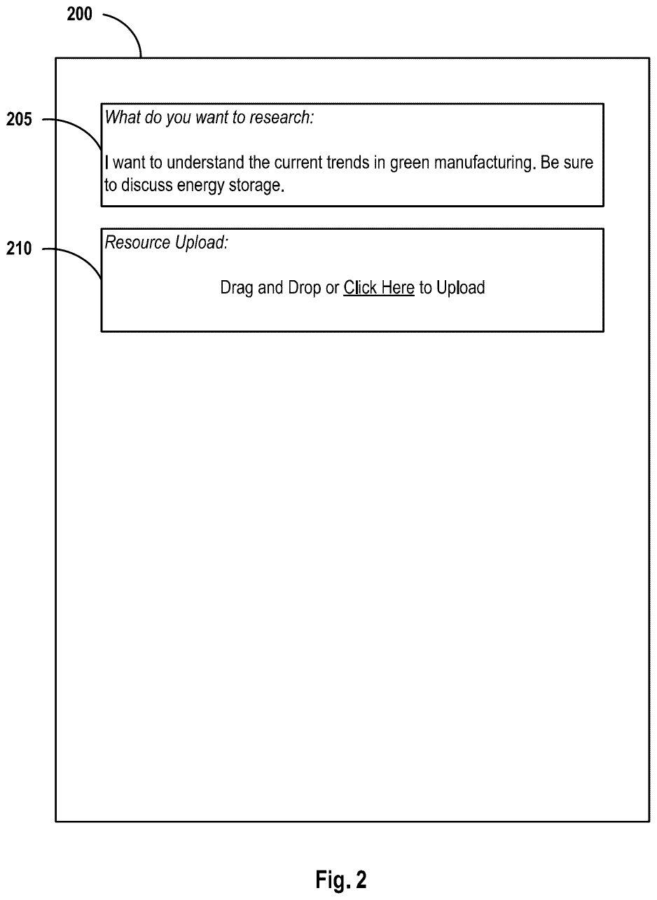

FIG. 2 depicts an example of a user interface 200 in accordance with various implementations herein. Implementations herein will be described in accordance with the previously-provided example of a research task related to clean energy. However, it will be understood that this description is a non-limiting example for the sake of discussion, and implementations are not limited to a particular topic. Similarly, it will be understood that the depictions of the user interface 200 and/or various elements of the user interface 200 are intended as highly simplified non-limiting examples. The specific size, shape, orientation, numbers of elements, etc. can differ in different implementations. For example, some elements can be combined, some elements can be separated into separate elements than depicted in one or more of the Figures herein, etc.

The example user interface 200 might include a user input portion 205 and a user-provided resource portion 210. In some implementations, the user can provide input to the system (e.g., a system such as that described with respect to FIG. 1) at the user input portion 205. In some implementations, the user-provided input can be, for example, written (e.g., typed) input, spoken input (such as might be translated via a speech-to-text engine), and/or some other type of input as previously described with respect to the user input engine 111. The user input can be, for example, related to a research task. In this example, the user has provided the following natural language input (e.g., using a physical or virtual keyboard): “I want to understand the current trends in green manufacturing. Be sure to discuss energy storage.” The user-provided resource portion 210 can be a portion of the user interface 200 where a user is able to upload one or more resources that are to be used by the system for the research task. For example, the user may be able to provide the resources as a document, as a portable document file (PDF), as an image file, as a video file, as an audio file, etc. The user might be able to provide the file by “clicking” or otherwise interacting with an element of the user the user-provided resource portion 210, by dragging and dropping an icon of the file, by providing a uniform resource locator (URL) associated with the file, etc.

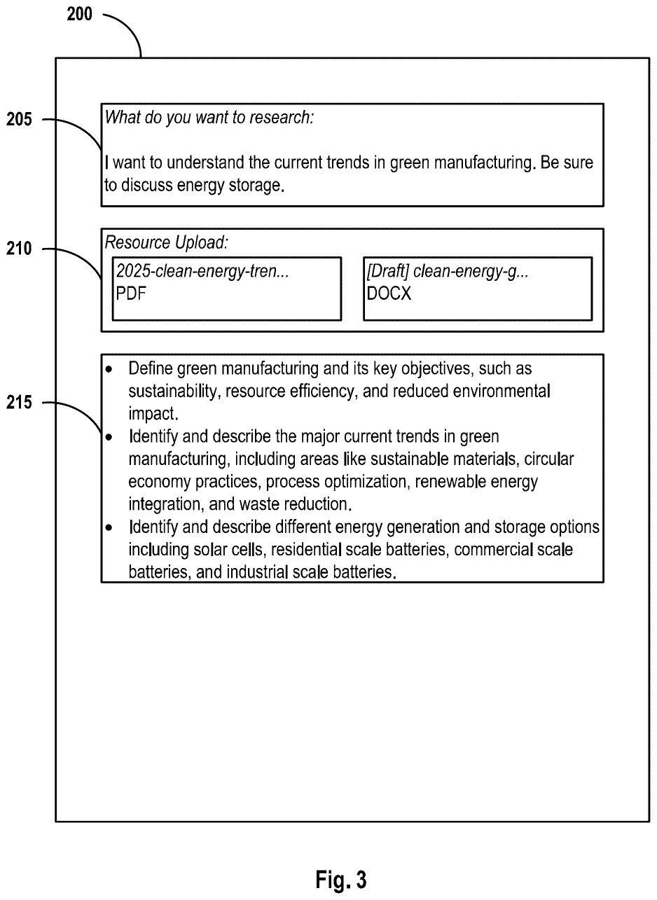

FIG. 3 depicts an example of an iteration of the user interface 200. As shown at 210, the user has provided two files. A first file is a PDF, and a second file is a document open extensible Markup Language (DOCX) file.

FIG. 3 further depicts a research sub-task portion 215. As can be seen in FIG. 3, the research sub-task portion 215 lists a plurality of research sub-tasks. The research sub-tasks can be generated based on a research task associated with the user input in the user input portion 205. For example, the user might provide an input to the user input portion 205 of the user interface 200 (e.g., via user input engine 111 and/or application(s) 115 of companion device 110) such as that previously given above in the example: “I want to understand the current trends in green manufacturing. Be sure to discuss energy storage.”

Based on the user input, the NL based response system 120 could use one or more of VLM(s) 150, to process the user input to generate sub-tasks such as the following research sub-tasks: “Define green manufacturing and its key objectives, such as sustainability, resource efficiency, and reduced environmental impact,” “Identify and describe the major current trends in green manufacturing, including areas like sustainable materials, circular economy practices, process optimization, renewable energy integration, and waste reduction,” and “Identify and describe different energy generation and storage options including solar cells, residential scale batteries, commercial scale batteries, and industrial scale batteries.” Indications of one or more of the sub-tasks could then be provided to the user as shown in FIG. 3, for example using rendering engine 112 and/or output device(s) 114 of the companion device 110 as previously described.

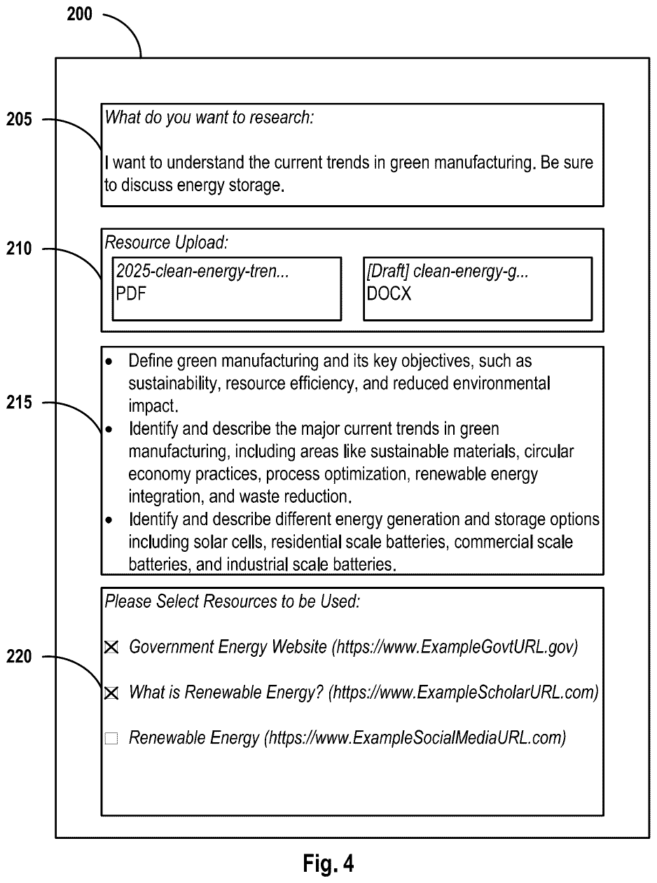

FIG. 4 depicts an example of a further iteration of the user interface 200. In this implementation, a user can be presented with one or more resources such as is shown at element 220 of FIG. 4. The resources can be resources that are usable by the system to perform one or more of the research task(s) and/or research sub-tasks(s) to generate research results. It will be understood that, although only three resources are depicted in FIG. 4, in other implementations more or fewer resources can be depicted.

The resources depicted at element 220 can be identified based on a variety of criteria. For example, in some implementations the resources can be identified based on, for example, one or more of the sub-tasks (e.g., those that are related to the specific research task being performed by the NL based response system 120). For example, one of the research sub-tasks that is identified in FIG. 3 is entitled: “Identify and describe different energy generation and storage options including solar cells, residential scale batteries, commercial scale batteries, and industrial scale batteries.” This research sub-tasks can be used to identify one or more related resources such as those that describe different types of batteries, different types of solar cells, etc. In some implementations, these resources might be identified using one or more GMs such as one or more of VLMs 150. In some additional or alternative implementations, some data stores might be pre-configured that could then be checked using different algorithms and/or non-GM based criteria. For example, an inverted index might be checked, a structured query language (SQL) query on a datastore might be issued, etc. to identify candidate resources based on terms present in one or more of the sub-tasks.

In some implementations, the one or more resources might be identified based on or using one or more pre-configured resources. For example, the NL based response system 120 can be pre-configured with one or more indications of resources that are to be used as initial resources presented to the user at 220. In some implementations, the one or more pre-configured resources might be edited to remove resources that are less relevant prior to presentation to the user at 220. Such editing might be performed using one or more of the VLMs 150 (e.g., by using one or more of the VLMs to analyze various of the pre-configured resources to identify which resources are more or less relevant than others). In some implementations, such editing might be performed using one or more non-GM algorithms or criteria as described above.

In some implementations, the candidate resources can be selected based on a characteristic of the resource. For example, in some implementations one or more of the VLMs 150 can be used (e.g., by the NL based response system 120) to analyze resources or resource categories identified at a previous query that was about that or a similar topic. The previously used sources can then be given higher weight. In some implementations, the system might prioritize research that occurred over the previous 12 months. In some implementations, the system could be biased to identify resources such as academic journals with strong editorial policies, and exclude less reliable resources such as those related to social media, blogs, online chat forums, etc.

In some implementations, the one or more resources might additionally or alternatively include one or more of the resources uploaded by the user at 210. It will be understood that the above-described examples of resource identification are intended as non-limiting example implementations, and other embodiments can include one or more additional or alternative methods or techniques of resource identification. Additionally, in some implementations the resource identification might occur at the companion device 110, the NL based response system 120, one or more of the further application(s) 160 (which might use one or more VLMs 150), and/or some other electronic device such as a server that is coupled with the network(s) 199.

After the resources are displayed at 220, the user might be able to select which resources are to be used. For example, FIG. 4 depicts the user selecting the first two resources (e.g., the government energy website and an academic article titled “What is Renewable Energy?”) and not selecting the third presented resource (e.g., a social media article related to renewable energy). Such selection might take a variety of forms. For example, the user might be presented with all of the suggested resources and then actively select the resource(s) that are to be used. In other implementations, all of the suggested resources might be selected by default, and the user might actively de-select the resources that are to not be used. The selection or de-selection can take a variety of forms. Non-limiting examples can include user actions such as hovering over a particular resource, clicking on the resource, gesturing to de-select a resource, vocalizing a selection of a resource, etc.

In some implementations, the user-uploaded resources at 210 might be assumed to be selected for inclusion, and so the system might not require the user to confirm selection of the user-uploaded resources. However, in other implementations, the user-uploaded resources at 210 might be presented to the user at 225 so that the user can actively or passively confirm selection of those resources or actively or passively de-select those resources (for example, if an alternative resource is presented at 225, and the user identifies that resource as being more relevant than one of the user-provided resources at 210).

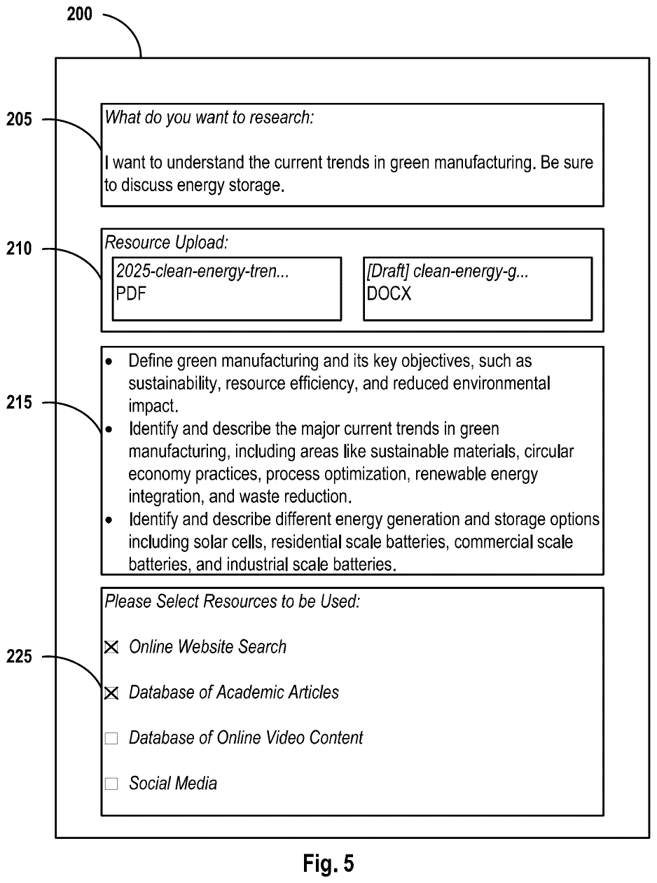

FIG. 5 depicts an alternative implementation wherein the user interface depicts examples of categories of resources at 225. Such a depiction can be used in addition to, or instead of, the depiction of resources at 220. For example, instead of listing specific references as shown at 220, element 225 can show categories of resources such as “online website search,” “database of academic articles,” “database of online video content,” and “social media.”

Similarly to element 220, the resource categories depicted at 225 can include more or fewer categories than are depicted in FIG. 4. The resource categories at 225 can be identified based on a variety of factors such as pre-configured resource categories, dynamically identified resource categories (e.g., based on one or more of the research sub-tasks), user-defined or user-indicated resource categories, etc. Such identification might be GM-based or based on a non-GM system or algorithm. A user can then actively select and/or de-select one or more of the suggested resource categories as described with respect to FIG. 4.

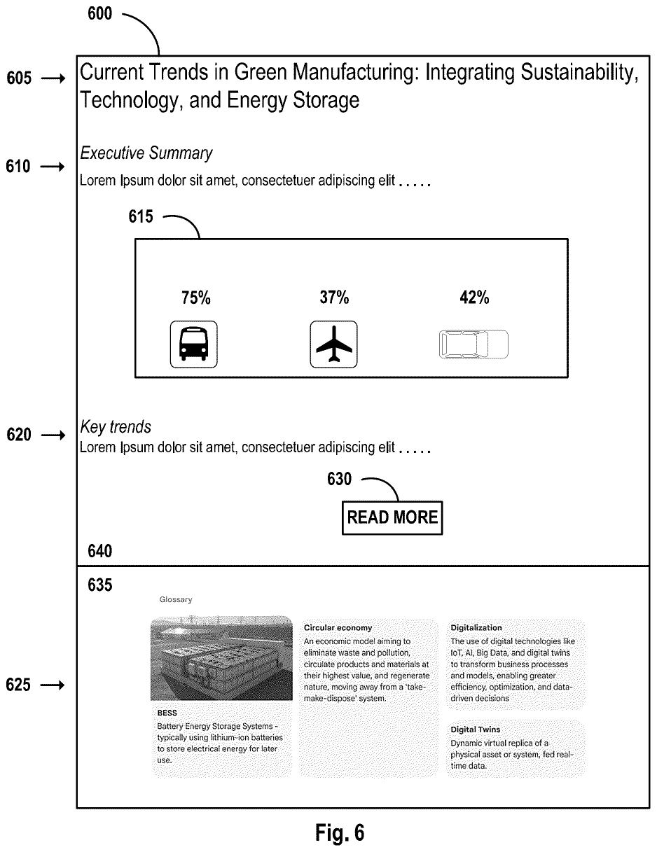

Based on one or more of the research task identified based on the user input at 205, the user-provided resources at 210, the one or more generated research sub-tasks at 215, the user-selected resources at 220, and/or the user-selected resource categories at 225, the system of FIG. 1 can perform one or more of the identified research task and/or one or more of the research sub-tasks to generate research results as shown in FIG. 6.

As an example, FIG. 6 depicts an example of a research report 600 that can be generated based on the generated research results. As previously described, VLM input could be generated by the VLM input engine 124 using various of the above-described elements such as those of FIGS. 2-5. Using this VLM input, the NL based response system 120 could use one or more of the VLMs 150 to generate one or more responses (e.g., research results) based on the research task and/or research sub-task(s). Generation of the one or more responses could include generation of a variety of textual and/or non-textual elements that could subsequently be provided to the user via the user interface 200 and/or rendering engine 112 of the companion device 110.

The example research report 600 of FIG. 6 includes a variety of textual elements, non-textual elements, and elements that include both textual and non-textual elements. For example, continuing with the example research task described with respect to FIGS. 2-5, the research report could include a textual element of a title portion at 605. In some implementations, the title portion at 605 could be generated based on the user-provided input to the user input portion 205. In this example, the title portion at 605 is “Current Trends in Green Manufacturing: Integrating Sustainability, Technology, and Energy Storage.” Another example textual element is depicted at 610. Specifically, this textual element could be an executive summary that provides a generated overview of the contents of the report. A further textual element is depicted at 620 which describes key trends related to the research topic (e.g., green manufacturing).

An example non-textual element is depicted at 615. The non-textual element could be, for example, a graphic, a flowchart, an audio element (e.g., such as an element that can be played based on user-interaction), a video element, and/or some other type of element that includes information presented in a non-textual form. In the example of FIG. 6, the non-textual element at 615 depicts a graphic showing three different types of transportation, and percentages above each. The information presented could be, for example, the percentage of each market segment of the transportation market uses green energy in some form. In this example, the non-textual element at 615 is depicted in-line with other textual elements 610 and 620 of the research report.

Another example element is depicted at 625. The element at 625 is depicted as including both textual and non-textual elements. For example, the element at 625 is a Glossary that could, for example, be used to define terms used in the research report 600. As shown, some terms (e.g., “BESS”) could include an associated graphic non-textual element.

It will be noted that element 625 is depicted as being in a separate portion 635 of the research report 600 than the portion 640 wherein other elements 605, 610, 615, and 620 are depicted. In some implementations, the portion 635 of the research report 600 might remain static while a user advances through the other portion 640 (e.g., through manipulation of the interactive “READ MORE” element 630). In some implementations, the user may be able to scroll through or otherwise interact with both portions 635 and 640. In some implementations, portions 635 and 640 may be beside one another, rather than arranged with one before or after the other. In some implementations, one or more additional non-textual elements might be depicted before the first textual element or subsequent to a last textual element in a portion where textual elements are rendered (e.g., portion 640).

It will be understood that the example research report at 600 is intended as a non-limiting example of such a research report. For example, a different arrangement, configuration, size, number, etc. of the various elements could be present in other research reports. In some implementations, the research report 600 might not have an in-line non-textual element such as that depicted at 615. In some implementations, the research report 600 might not have a non-textual element or an element with mixed textual and non-textual aspects such as that depicted at 625. Other implementations might vary in other ways.

It will be noted that the above example of FIGS. 2-6 is described as being based on generation using one or more GMs such as the VLMs 150. However, such description is intended as one description of one example, and other implementations might vary. For example, VLMs are described as identifying one or more of the sub-tasks depicted at 215, identifying one or more of the resources depicted at 220, identifying one or more of the resource categories depicted at 225, and generating one or more of the textual and/or non-textual elements depicted in research report 600. In some implementations, different GMs or different types of GMs could be used for different ones of the above-described tasks. For example, a relatively light-weight GM and/or a non-GM based algorithm could be used for a smaller task such as resource identification or sub-task-identification. By contrast, a more complex GM could be used for a more in-depth task such as performing one or more of the research sub-tasks. A more complex GM could be desirable for the more in-depth task, because performance of one or more of the sub-tasks could be more computationally or informationally demanding than sub-task identification or resource identification.

Similarly, in some implementations, the processing using one or more of the GMs could be performed using different electronic devices within the system of FIG. 1. For example, sub-task or resource identification could be performed using a NL based response system 120 that is at least partially implemented using one or more processors of the companion device 110. By contrast, the more computationally demanding and computationally expensive task of performing the one or more research sub-tasks could be performed by at least a portion of a NL based response system 120 that is remote from the companion device 110 (e.g., a server or data center that could be coupled with the companion device 110 via the one or more networks 199). Performing this processing remotely from the companion device 110 could be desirable because the remote electronic device might have advanced memory or processing power that allows for the more computationally demanding research task (and/or one or more research sub-tasks) to be performed in a more efficient manner. Information related to the results of the research task (and/or one or more research sub-tasks) could then be conveyed to the companion device 110 for rendering as previously described.

In some implementations, a portion of the research task and/or research sub-tasks could be performed by a remote NL based response system 120, and another portion of the research task and/or research sub-tasks could be performed by a NL based response system 120 that is implemented by the companion device 110. For example, the remote NL based response system 120 could process one or more of the research task(s)/sub-task(s) using one or more remote GMs, and then provide information to the companion device 110. A NL based response system 120 of the companion device 110 could then generate one or more of the various textual and/or non-textual elements based on the information received from the remote NL based response system 120.

It will be understood that the above-described implementations are intended as non-limiting examples of such systems. Other implementations could have other variations. For example, a first VLM could be used for generation of a textual element, another VLM could be used for generation of a non-textual graphic element, and a third VLM could be used for generation of an audio element. In other implementations, the same VLM could be used for generation of two or more textual and/or non-textual elements.

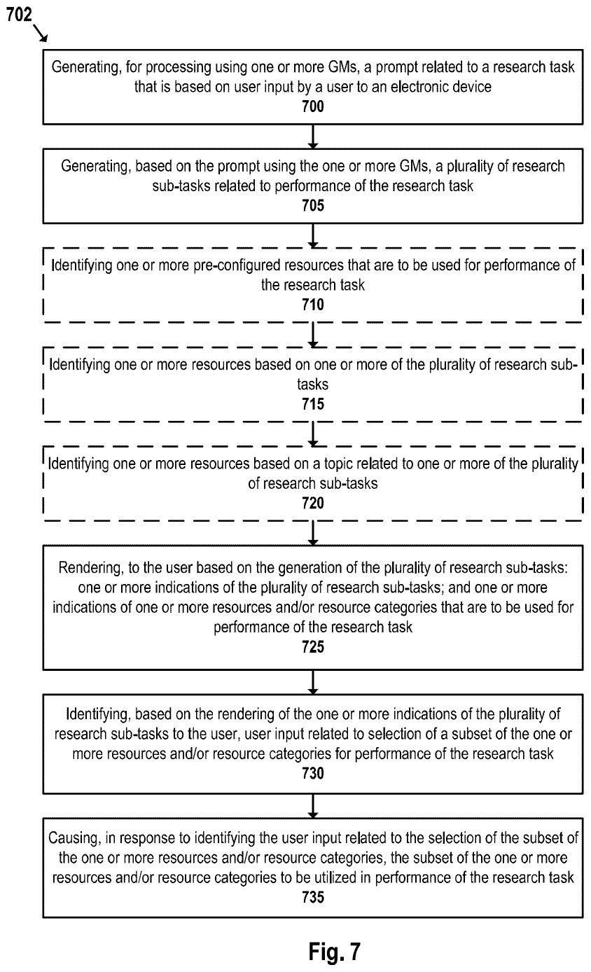

FIG. 7 depicts an example process 702 related to various implementations herein. At block 700, the process 702 can include generating, for processing using one or more generative models (GMs), a prompt related to a research task that is based on user input by a user to an electronic device. The user might, for example, type a phrase into a field of a user interface that relates to a question on a research topic (such as that depicted at element 205 of FIGS. 2-5). The phrase can be analyzed to provide a starting point for an information repository.

At block 705, the process 702 can include generating, based on the prompt using the one or more GMs, a plurality of research sub-tasks related to performance of the research task. For example, the NL based response system 120 could identify a query based on the user input, and then use one or more of VLM(s) 150 to process the user input to generate a research task and one or more sub-tasks that address different components of the query related to the overall research topic. These sub-tasks might then guide how various aspects of the subsequent research proceeds, such as resource selection, information filtering, etc.

In some implementations, block 705 can include performing one or more of the plurality of research sub-tasks using the one or more GMs. For example, the research sub-tasks might provide a starting point of phrases to be used to initiate research activities via one or more GM, and those activities could lead to additional and further generation of sub-tasks.

At block 710, the process 702 can optionally include identifying one or more pre-configured resources that are to be used for performance of the research task. For example, the NL based response system 120 can be pre-configured with one or more indications of resources that are to be used as initial resources presented to the user at 220.

At block 715, the process 702 can optionally include identifying one or more resources based on one or more of the plurality of research sub-tasks. For example, the resources depicted at element 220 can be identified based on, for example, one or more of the sub-tasks (e.g., those that are related to the specific research task being performed by the NL based response system 120).

At block 720, the process 702 can optionally include identifying one or more resources based on a topic related to the research task and/or one or more of the plurality of research sub-tasks. For example, in some implementations, one or more of the VLMs 150 can be used (e.g., by the NL based response system 120) to analyze resources or resource categories identified at a previous query that was about that or a similar topic. The previously used sources can then be given higher weight.

It will be noted that elements 710, 715, and 720 are described as “optional.” This description is made for the sake of indicating that various implementations can include one of the described elements, two of the described elements, or three of the described elements.

At block 725, the process 702 can include rendering, to the user based on the generation of the plurality of research sub-tasks, one or more indications of the plurality of research sub-tasks and one or more indications of one or more resources and/or resource categories that are to be used for performance of the research task. Indications of one or more of the sub-tasks could then be provided to the user as shown in FIG. 3, for example using rendering engine 112 and/or output device(s) 114 of the companion device 110 as previously described. Similarly, candidate resources such as those displayed at element 220 of FIG. 4 or resource categories such as those displayed at element 225 of FIG. 5 might also be rendered to the user (again, for example using rendering engine 112 and/or output device(s) 114 of the companion device 110 as previously described).

At block 730, the process 702 can include identifying, based on the rendering of the one or more indications of the plurality of research sub-tasks to the user, user input related to selection of a subset of the one or more resources and/or resource categories for performance of the research task. For example, FIG. 4 depicts the user selecting the first two resources (e.g., the government energy website and a website that holds an academic article) and not selecting the third presented resource (e.g., a social media article related titled “Renewable Energy”). Similar selection is depicted with respect to resource categories in FIG. 5.

At block 735, the process 702 can include causing, in response to identifying the user input related to the selection of the subset of the one or more resources (and/or resource categories), the subset of the one or more resources (and/or resource categories) to be utilized in performance of the research task. For example, the system might exclude or disregard certain of the resources depending on how those resources have been selected and/or de-selected (or a category of the resources has been selected/de-selected). In other words, if the user input at 730 resulted in a determination that a specific resource or resource category was to be utilized, the information from that resource or information related to the resource category could then be used in the subsequent generation of the information presented in FIG. 6 as previously described.

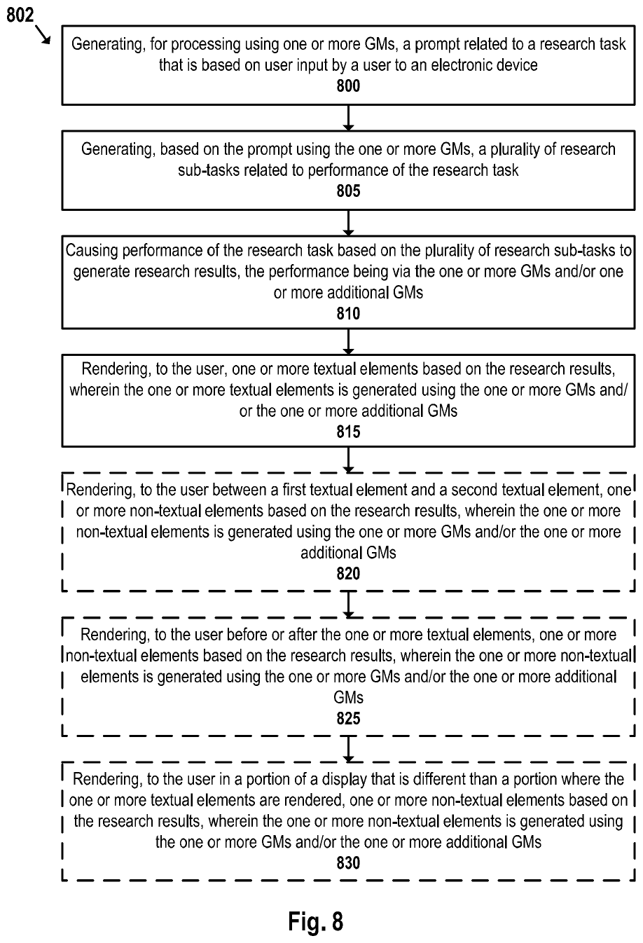

FIG. 8 depicts another example process 802, in accordance with implementations herein. Elements 800 and 805 are generally similar to, and share one or more characteristics with, elements 700 and 705. Description of those elements will not be repeated herein for the sake of conciseness.

At block 810, the process 802 can include causing performance of the research task based on the plurality of research sub-tasks to generate research results, the performance being via the one or more GMs and/or one or more additional GMs (e.g., local GMs and/or remote GMs as previously described). Such research can be similar to, for example, element 735 of FIG. 7.

At block 815, the process 802 can include rendering, to the user, one or more textual elements based on the research results, wherein the one or more textual elements may be generated using the one or more GMs and/or one or more additional GMs. In some implementations, block 815 can include content generated using the one or more GMs and/or the one or more additional GMs to provide information related to a topic of the research task. In some implementations, block 815 can include one or more indications of one or more resources used for performance of the research task. In some implementations, block 815 can include one or more indications of topics related to a topic of the research task.

At block 820, the process 802 can optionally include rendering, between two textual elements, one or more non-textual elements based on the research results, wherein the one or more non-textual elements may be generated using the one or more GMs and/or the one or more additional GMs. Such a non-textual element can be, for example, element 615 of FIG. 6.

At block 825, the process 802 can optionally include rendering, to the user before or after the one or more textual elements, one or more non-textual elements based on the research results, wherein the one or more non-textual elements may be generated using the one or more GMs and/or the one or more additional GMs.

At block 830, the process 802 can optionally include rendering, to the user in a portion of a display that may be different than a portion where the one or more textual elements are rendered (e.g., portion 635), one or more non-textual elements based on the research results, wherein the one or more non-textual elements may be generated using the one or more GMs and/or the one or more additional GMs.

It will be noted that elements 820, 825, and 830 are described as “optional.” This description is made for the sake of noting that one of the described elements, two of the described elements, or three of the described elements can occur in various implementations.

It will be understood that the example processes 702 and 802 of FIGS. 7 and 8 are intended as high-level non-limiting examples of such processes, and other implementations can vary. For example, in other implementations, various of the depicted elements might be combined, or an element might be split into multiple elements. In some implementations, some depicted elements might not be present, or additional elements might be included. In some implementations, the order in which one or more elements are performed might be different than depicted. Other implementations might have additional or alternative variations.

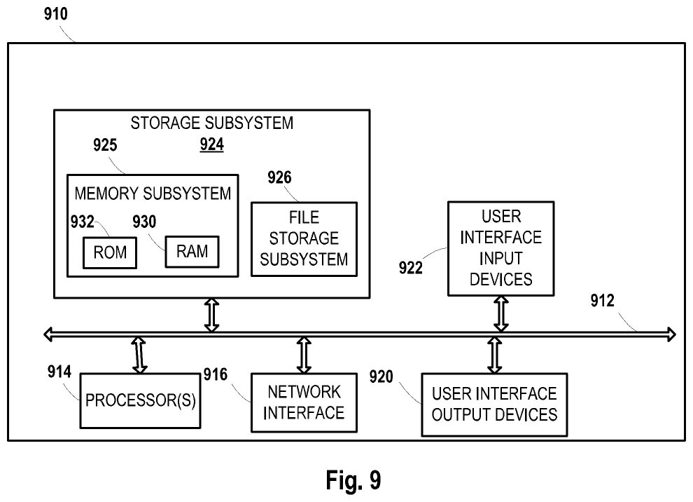

FIG. 9 is a block diagram of an example computer system 910. Computer system 910 typically includes processor(s) 914 which communicates with a number of peripheral devices via bus subsystem 912. These peripheral devices may include a storage subsystem 924, including, for example, a memory subsystem 925 and a file storage subsystem 926, user interface output devices 920, user interface input devices 922, and a network interface subsystem 916. The input and output devices allow user interaction with computer system 910. Network interface subsystem 916 provides an interface to outside networks and is coupled to corresponding interface devices in other computer systems.

In various implementations, computer system 910 could be or implement one or more of the companion device 110, the NL based response system 120, the application(s) 160, etc. In some implementations, the storage subsystem 924 could store one or more of VLMs 150, or implement one or both of storage devices 116/138.

User interface input devices 922 may include a keyboard, pointing devices such as a mouse, trackball, touchpad, or graphics tablet, a scanner, a touchscreen incorporated into the display, audio input devices such as voice recognition systems, microphones, and/or other types of input devices. In general, user interface input devices 922 may include any device for inputting information into computer system 910.

User interface output devices 920 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, user interface output devices 920 may include any device for outputting information from computer system 910 to the user or to another machine or computer system.

Storage subsystem 924 stores programming and data constructs that provide the functionality of some or all of the modules described herein. For example, the storage subsystem 924 may include the logic to perform selected aspects of the method of FIG. 7 or 8. These software modules are generally executed by processor(s) 914 alone or in combination with other processors. Processor(s) 914 may take various forms, such as a central processing unit (CPU), a graphics processing unit (GPU), a tensor processing unit (TPU), a neural processing unit (NPU), and so forth.

Memory 925 used in the storage subsystem 924 can include a number of memories including a main random access memory (RAM) 930 for storage of instructions and data during program execution and a read only memory (ROM) 932 in which fixed instructions are stored. A file storage subsystem 926 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 926 in the storage subsystem 924, or in other machines accessible by the processor(s) 914.

Bus subsystem 912 provides a mechanism for letting the various components and subsystems of computer system 910 communicate with each other as intended. Although bus subsystem 912 is shown schematically as a single bus, alternative implementations of the bus subsystem may use multiple busses.

Computer system 910 can be of varying types including a workstation, server, computing cluster, blade server, server farm, or any other data processing system or computing device. Due to the ever-changing nature of computers and networks, the description of computer system 910 depicted in FIG. 9 is intended only as a specific example for purposes of illustrating some implementations. Many other configurations of computer system 910 are possible having more or fewer components than the computer system depicted in FIG. 9.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used. Moreover, features described herein may be activated, deactivated, and reactivated at the individual's discretion.

In some implementations, a method implemented by processor(s) is provided and includes generating a prompt related to a research task based on user input. The method includes generating a plurality of research sub-tasks related to performance of the research task based on the prompt. Rendering, to the user based on the generation of the plurality of research sub-tasks, includes rendering one or more indications of the plurality of research sub-tasks and one or more indications of one or more resources that are to be used for performance of the research task. The method includes identifying, based on the rendering of the one or more indications of the plurality of research sub-tasks to the user, user input related to selection of a subset of the one or more resources for performance of the research task. In response to identifying the user input related to the selection of the subset of the one or more resources, the method includes causing the subset of the one or more resources to be utilized in performance of the research task.

In some implementations, pre-configuration of one or more resources can occur before generation of the prompt that is related to the research task.

In some implementations, the method can include identifying the one or more resources based on one or more of the plurality of research sub-tasks.

In some versions of those implementations, identification of the one or more resources can be based on a topic related to one or more of the plurality of research sub-tasks.

In some implementations, one or more of the plurality of research sub-tasks might be to be performed using the one or more GMs.

In some implementations, a subset of the one or more resources might be fewer than all of the one or more resources.

In some implementations, user input related to selection of a subset of the one or more resources can include user input related to selection of one or more categories of the one or more resources.

In some of those implementations, the one or more categories can be academic journals.

In some of those implementations, the one or more categories can be websites.

In some of those implementations, the one or more categories can be videos.

In some implementations, the one or more resources can be user-provided resources.

In some implementations, a method implemented by processor(s) can include generating, for processing using one or more GMs, a prompt related to a research task that is based on user input by a user to an electronic device. A plurality of research sub-tasks related to performance of the research task can be generated based on the prompt using the one or more GMs. The research task can be performed based on the plurality of research sub-tasks to generate research results, the performance being via the one or more GMs and/or one or more additional GMs. One or more textual elements can be rendered to the user based on the research results, wherein the one or more textual elements are generated using the one or more GMs and/or the one or more additional GMs. One or more non-textual elements can then be rendered to the user based on the research results, where the non-textual elements can be generated using the one or more GMs and/or one or more additional GMs.

In some implementations, a non-textual element can include an audio element.

In some implementations, the non-textual element can be a graph or a flowchart.

In some implementations, the non-textual element can be a non-textual visual element.

In some implementations, the textual element can include content generated using the one or more GMs and/or the one or more additional GMs to provide information related to a topic of the research task.

In some implementations, the textual elements can include one or more indications of one or more resources used for performance of the research task.

In some implementations, the one or more textual elements can include one or more indications of topics related to a topic of the research task.

In some implementations, the non-textual elements can be rendered between a first textual element and a second textual element.

In some implementations, the non-textual elements can be rendered before or after one or more of the textual elements.

In some implementations, the non-textual element can be rendered in a portion of the display that is different from a portion where one or more of the textual elements are rendered.

Other implementations may include a transitory or non-transitory computer readable storage medium storing instructions executable by a processor to perform a method such as one or more of the methods described above. Yet another implementation may include a system including memory and one or more processors operable to execute instructions, stored in the memory, to implement one or more modules or engines that, alone or collectively, perform a method such as one or more of the methods described above.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A computer-implemented method comprising:
generating, for processing using one or more generative models (GMs), a prompt related to a research task that is based on a first user input by a user to an electronic device;
generating, based on the prompt using the one or more GMs, a plurality of research sub-tasks related to performance of the research task;
rendering, to the user based on the generation of the plurality of research sub-tasks:
one or more indications of the plurality of research sub-tasks; and
one or more indications of one or more resources that are to be used for performance of the research task;
identifying, subsequent to the rendering of the one or more indications of the plurality of research sub-tasks to the user, a second user input related to selection of a subset of the one or more resources for performance of the research task;
causing, in response to identifying the second user input related to the selection of the subset of the one or more resources, the subset of the one or more resources to be utilized in performance of the research task;
performing, using the subset of the one or more resources, the plurality of research sub-tasks to generate a plurality of results that respectively correspond to the plurality of research sub-tasks; and
causing the plurality of results to be output.

2. The computer-implemented method of claim 1, wherein the one or more resources are pre-configured prior to generation of the prompt related to the research task.

3. The computer-implemented method of claim 1, wherein the method further comprises identifying the one or more resources based on one or more of the plurality of research sub-tasks.

4. The computer-implemented method of claim 3, wherein the method further comprises identifying the one or more resources based on a topic related to one or more of the plurality of research sub-tasks.

5. The computer-implemented method of claim 1, wherein one or more of the plurality of research sub-tasks are to be performed using the one or more GMs.

6. The computer-implemented method of claim 1, wherein the subset of the one or more resources is fewer than all of the one or more resources.

7. The computer-implemented method of claim 1, wherein the second user input related to the selection of the subset of the one or more resources includes input related to selection of one or more categories of the one or more resources.

8. The computer-implemented method of claim 7, wherein the one or more categories include a category related to academic journals.

9. The computer-implemented method of claim 7, wherein the one or more categories include a category related to websites.

10. The computer-implemented method of claim 7, wherein the one or more categories include a category related to videos.

11. The computer-implemented method of claim 1, wherein the one or more resources include one or more user-provided resources.

12. A computer-implemented method comprising:
generating, for processing using one or more generative models (GMs), a prompt related to a research task that is based on user input by a user to an electronic device;
generating, based on the prompt using the one or more GMs, a plurality of research sub-tasks related to performance of the research task;
causing, using the one or more GMs and/or one or more additional GMs, performance of the plurality of research sub-tasks to dynamically generate a plurality of research results that respectively correspond to the plurality of research sub-tasks, wherein the plurality of research results include at least one textual element and at least one non-textual element;
causing the at least one textual element to be rendered to the user; and
causing the at least one non-textual element to be rendered to the user.

13. The computer-implemented method of claim 12, wherein the at least one non-textual element includes an audio element.

14. The computer-implemented method of claim 12, wherein the at least one non-textual element includes a visual element.

15. The computer-implemented method of claim 12, wherein the at least one textual element includes content generated using the one or more GMs and/or the one or more additional GMs to provide information related to a topic of the research task.

16. The computer-implemented method of claim 12, wherein the at least one textual element includes one or more indications of one or more resources used for performance of the research task.

17. The computer-implemented method of claim 12, wherein the at least one textual element includes one or more indications of topics related to a topic of the research task.

18. The computer-implemented method of claim 12, wherein the at least one textual element includes a first textual element and a second textual element, and wherein the at least one non-textual element is rendered between the first textual element and the second textual element.

19. The computer-implemented method of claim 12, wherein the at least one non-textual element is rendered before or after the at least one textual element.

20. The computer-implemented method of claim 12, textual elements are rendered wherein the at least one non-textual element is rendered in a portion of a display that is different from a portion where the at least one textual element is rendered.
